(19) United States
(12) Patent Application Publication
(10) Pub. No.: US 2009/0287511 A1
(43) Pub. Date: Nov. 19, 2009

(54) METHOD OF OBTAINING PREPAYMENT OF A CONTRACT PAYMENT

(75) Inventors: Johnnie B. Carroll, West Chester, OH (US); Lydia Joo, Cincinnati, OH (US); Sara Shelton, Lebanon, OH (US); Greg Cosco, Loveland, OH (US)

Correspondence Address: BARLOW, JOSEPHS & HOLMES, LTD., 101 DYER STREET, 5TH FLOOR, PROVIDENCE, RI, 02903, US

(73) Assignee: CITIZENS FINANCIAL GROUP, INC., Providence, RI (US)

(21) Appl. No.: 12/464,929

(22) Filed: May 13, 2009

Related U.S. Application Data
(60) Provisional application No. 61/052,693, filed on May 13, 2008.

(51) Int. Cl. G06Q 40/00; G06K 15/00; G06Q 30/00

(52) U.S. Cl. 705/4; 235/383; 705/1

(57) ABSTRACT

A method for conducting a transaction is provided wherein a consumer prepays for a service in a traditional retail transaction to obtain a voucher that allows the customer, at a later time and date, to complete the enrollment process in order to obtain the underlying service. In general operation, a customer selects a desired service that is represented by a tangible product representation, such as a gift card or the like. That product representation is then presented to the cashier at the retail location like any other product and the customer pays the cashier for the product. The settlement value for the retail transaction is sent to the service provider and the customer uses the product representation to contact the service provider to complete the transaction for services and establish a contract or account.

### CROSS-REFERENCE TO RELATED APPLICATIONS

This application is related to and claims priority from earlier filed U.S. Provisional Patent Application No. 61/052,693, filed May 13, 2008.

### BACKGROUND OF THE INVENTION

The present invention relates generally to a method for conducting a transaction that allows the collection of an advance monetary prepayment for a contract to be entered into at a later time. More specifically, the present invention relates to a method of conducting a transaction whereby the purchase of a contract is converted to an impulse level purchase, wherein the consumer prepays a contract payment and then later creates an account that is matched with that payment to create the contract.

In the marketplace today, there are a wide variety of goods and services are available to customers that are positioned in a manner that reduces the purchasing decision to an impulse purchase. In other words, the goods or services are displayed and advertised in such a manner that the decision to make the purchase is made on the spur of the moment with little or no contemplation on the part of the consumer. While this approach works for a large number of different goods and services, there are other products that require more effort on the part of the consumer in terms of completing the purchase. For example, a purchase involving the formation of a contract or services or insurance generally requires more time and effort in a manner that ultimately prevents the purchase from being completed on an impulse basis. Often the consumer's decision to complete the purchase of such products is postponed due to the increased effort required. Once such a purchase has been postponed, the consumer then gets into a mind set that there is no immediacy to their need to complete a purchase since they can always go back at a later date to complete the purchase. However, since a large percentage of consumer sales are based upon the impulse purchasing phenomenon, should a consumer postpone the purchasing decision it is likely that the purchase impulse may pass before their return.

Further adding to this difficulty, there are many types of goods and services that are dependent upon customers establishing relationships with service provides such as banks, credit unions, insurance companies, etc. at the outset of the relationship, thereby increasing the time and complexity required to make the purchase of the desired product. To address this problem, a variety of products are now available to provide at least partial solution in the form of prepaid service cards that allow a consumer to pre-purchase various goods and services. For example, in the field of telecommunications services, customers can buy prepaid calling cards or prepay on a monthly basis for dial tone service. While such prepaid services work for basic forms of goods and services, they do not solve the problem for those goods and services, such as insurance products for example, wherein a relationship still must be established between the consumer and the service provider and wherein the parties exchange information that serves as the underpinning of the relationship.

In view of the foregoing, there is a need for a method of conducting a transaction wherein a customer, making an impulse purchase, completes the purchase of a prepaid voucher or the like that in turn enables the customer to establish a relationship with a service provider at a later date. There is a further need for a method of conducting a transaction for the purchase of services that reduces such a purchase to an impulse buy, yet enables the customer, at a later time and place, to provide information to the service provider to establish the required underlying relationship.

### BRIEF SUMMARY OF THE INVENTION

In this regard, the present invention provides a method for conducting a transaction wherein a consumer prepays for a service in a traditional retail transaction to obtain a voucher that allows the customer, at a later time and date, to complete the enrollment process in order to obtain the underlying service. In general operation, the method of the present invention provides for a customer, at a retail location, to select a desired service that is represented by a tangible product representation, such as a gift card or the like. That product representation is then presented to the cashier at the retail location like any other product and the customer pays the cashier for the product. The settlement value for the retail transaction is sent to the service provider. The customer then uses the product representation to contact the service provider to complete the transaction for services and establish a contract or account within the scope of the terms identified in the product representation selected by the customer.

In one embodiment, the method of the present invention may be employed for the purchase of an insurance product, such as an accidental insurance policy for pets. In this context, the customer while shopping at a pet related retailer is presented with the ability to select a product package related to pet insurance policies. Once selected, the package is then purchases and the face value of the package is then applied as a premium prepayment towards a pet insurance policy.

It is of note that the method of the present invention also allows the purchase of services by one customer for the benefit of others. For example in the context of pet insurance described above, the product package may be purchased as a gift and give to a third party who then in turn proceeds to complete the product activation themselves.

Accordingly, it is an object of the present invention to provide a method of conducting a transaction wherein a customer, making an impulse purchase completes the purchase of a prepaid voucher or the like that in turn enables them to establish a relationship with a service provider at a later date. It is a further object of the present invention to provide a method of conducting a transaction for the purchase of services that reduces such a purchase to an impulse buy, yet enables the customer, at a later time and place, to provide information to the service provider to establish the required underlying relationship. It is still a further object of the present invention to provide a method of conducting a transaction for the purchase of services by one party for the benefit of third party that then enables the third party, at a later time and place, to provide information to the service provider to establish the required underlying relationship.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a flow chart illustrating the method and system of the present invention.

### DETAILED DESCRIPTION OF THE INVENTION

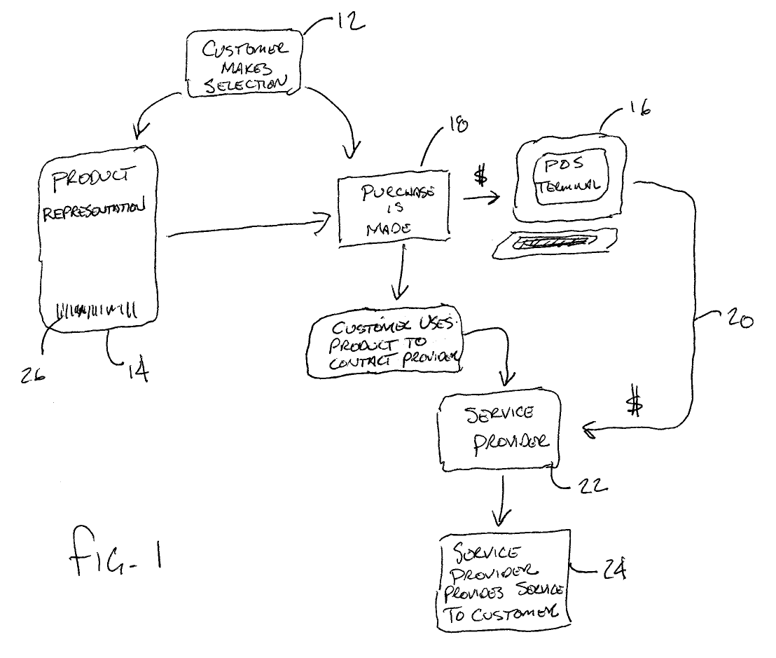

Now referring to the drawings, the method and system of the present invention is shown and generally illustrated in FIG. 1. As can be seen, the present invention provides a method for conducting a transaction wherein a consumer prepays for a service in a traditional retail transaction to obtain a voucher that allows the customer, at a later time and date, to complete the enrollment process in order to obtain the underlying service.

In the most general form, as illustrated at FIG. 1, the method of the present invention provides for a customer 12, at a retail location, to select a desired service that is represented by a tangible product representation 14, such as a gift card or the like. That product representation 14 is then presented at a retail location 16 like any other product and the customer pays 18 the cashier for the product representation 14. The settlement value 20 for the retail transaction is sent to the service provider 22. The customer 12 then uses the product representation 14 to contact the service provider 22 to complete the transaction for services 24 and establish a contract or account within the scope of the terms identified in the product representation selected by the customer.

It should be appreciated that while the term retail location is employed herein, the scope of the term retail location is intended to cover any type outlet wherein a customer can make a retail purchase including both bricks and mortar type installations and virtual retail locations including but not limited to Internet web pages. Additionally, while the present invention will be described below in terms of a specific example related to an insurance product, it should be appreciated by one skilled in the art that this is meant only to be illustrative as the method of the present invention as generally outlined above may be adapted for an unlimited number of similar products and/or services.

In one illustrative example of the method of the present invention, the method may be employed for the purchase of an accidental insurance policy. Such a policy may be for pets, for vacations or for air travel to name only a few possibilities. In the context of accidental insurance for pets, the customer is presented with the ability to select a product package 14 related to pet insurance policies while shopping at a pet related retailer. Such a product package 14 may be in the form of a box that contains policy related literature, information about the service provider 22 and instructions for activation of the policy. The product package 14 also includes a machine-readable barcode 26 in a standard format that allows the package 14 to be scanned and identified by a standard point of sale (POS) terminal 16. In one example such a package 14 may have a face value of $49.99 and be applied as a premium prepayment for 6-months of a 12-month pet insurance policy.

Once the customer 12 selects the product, it is taken to a POS terminal 16 and the purchase is completed as is well known in the art. The customer 12 pays the cashier for the product and the remittance is forwarded 20 through an electronic transaction network to the service provider 22, in this case a company that offers pet insurance policies. At a later time and date, the customer, following instruction on the product package 14, contacts the pet insurance service provider 22 to activate their policy. To facilitate identification of the customer and the purchased package, the product package may include one or more security and/or activation codes that the customer provides to the service provider for activation of the policy. Further, to activate the policy, the customer 12 may contact the service provider 22 via mail, telephone or Internet.

While in the illustration provided above, the purchase is made at a traditional bricks and mortar location, it is equally applicable within the scope of the present invention that the purchase of goods or services may be made at a traditional retailer, via an online retailer, through a catalog or via telephone. Regardless of the manner in which the purchase of goods or services is made, the initial transaction is processed via the existing electronic funds transfer network wherein the face value of the purchase is processed using the information imprinted or encoded on the product package. In this manner the initial transaction is then posted to a corresponding account maintained by the service provider for later access by the ultimate consumer of the services represented by the product package.

An additional benefit of the method of the present invention is that it allows the purchase of services by one customer for the benefit of others. For example in the context of pet insurance described above, the product package may be purchased as a gift and give to a third party who then in turn proceeds to complete the product activation themselves. Accordingly, it can be seen that the method of the present invention allows the purchase of certain non-traditional services through the same channels as a traditional retail impulse purchase while also allowing such services to be easily purchased as a gift for another.

It should be appreciated that, there are many other contexts to which the transaction method of the present invention may apply. Further, while the present invention has been described in terms of specific insurance services, it is also anticipated that the transaction method of the present invention is equally applicable to any other type of goods or services for which premium payments may be required.

It can therefore be seen that the present invention provides a method of conducting a transaction wherein a customer completes the purchase of a prepaid voucher or the like that in turn enables them to establish a relationship with a service provider at a later date in a manner that reduces the purchase of services to an impulse buy, yet enables the customer, at a later time and place, to provide information to the service provider to establish the required underlying relationship. Further, the method of conducting a transaction in the present invention allows for the purchase of services by one party for the benefit of third party that then enables the third party, at a later time and place, to provide information to the service provider to establish the required underlying relationship. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A transaction method for collecting prepayment for a service contract comprising:
providing a product representation at a retail location, said product representation containing an offer of services from a service provider;
a customer selecting the product representation and presenting the product representation for purchase;
the customer completing the purchase wherein a settlement value for the purchase is transferred to the service provider; and
the customer then using the product representation to contact the service provider to obtain the services offered.

2. The transaction method of claim 1, wherein the product representation is a voucher for services.

3. The transaction method of claim 1, wherein the product representation is an electronic transaction card.

4. The transaction method of claim 3, wherein the electronic transaction card is packaged with literature related to the services, information about the service provider, instructions for obtaining the services and a machine-readable code that can be scanned and identified by a standard point of sale terminal.

5. The transaction method of claim 3, wherein the electronic transaction card includes at least one code thereon that the customer provides to the service provider in exchange for the services.

6. The transaction method of claim 1, wherein the product representation is a tangible product.

7. The transaction method of claim 6, wherein the tangible product is a box including literature related to the services, information about the service provider, instructions for obtaining the services and a machine-readable code that can be scanned and identified by a standard point of sale terminal.

8. The transaction method of claim 6, wherein the box includes at least one code thereon that the customer provides to the service provider in exchange for the services.

9. The transaction method of claim 1, wherein the customer contacts the service provider via mail, telephone or Internet

10. The transaction method of claim 1, wherein the initial purchase is a partial payment for the services.

11. The transaction method of claim 1, further comprising:
the customer contacting the service provider to enter a contract for services with the service provider wherein said settlement value is a partial payment for said services.

12. The transaction method of claim 1, wherein the services are insurance services.

13. The transaction method of claim 1, wherein the customer completes the purchase at a physical retail location or an electronic retail location.

14. The transaction method of claim 1, further comprising:
the customer gives the product representation to a third party; and
the third party contacts the service provider to obtain the services offered.

15. A transaction method for obtaining prepayment of a contract premium comprising:
providing a product representation at a retail location, said product representation containing an offer of services from a service provider and a premium amount to be paid for said services;
a customer selecting the product representation and completing a purchase transaction for the product representation, wherein said premium amount is transferred to the service provider; and
the customer then using the product representation to contact the service provider to obtain the services offered.

16. The transaction method of claim 15, wherein the product representation includes at least one code thereon that the customer provides to the service provider in exchange for the services.

17. The transaction method of claim 15, wherein the product representation is a box including literature related to the services, information about the service provider, instructions for obtaining the services and a machine-readable code that can be scanned and identified by a standard point of sale terminal.

18. The transaction method of claim 17, wherein the box includes at least one code thereon that the customer provides to the service provider in exchange for the services.

19. The transaction method of claim 15, wherein the services are insurance services.
